(19) United States
(12) Patent Application Publication
(10) Pub. No.: US 2006/0136474 A1
(43) Pub. Date: Jun. 22, 2006

(54) Customer service automatic answering system and method

(75) Inventors: Zechary Chang, Taipei (TW); Iris Yang, Beijing (CN); Chrysa Li, Beijing (CN)

Correspondence Address: Welsh & Katz, Ltd.;Eric D. Cohen, 22nd Floor, 120 South Riverside Plaza, Chicago, IL, 60606, US

(73) Assignee: Inventec Corporation, Taipei (TW)

(21) Appl. No.: 11/018,702

(22) Filed: Dec. 21, 2004

(51) Int. Cl. G06F 17/00

(52) U.S. Cl. 707/102

(57) ABSTRACT

A customer service automatic answering system and method aims to receive question contents entered by users, access the keywords of the question contents, search targeted topic contents in an answer database that match the keywords, and send answering data corresponding to the targeted topic contents to the network user for displaying, so that an automatic and instant answer may be performed and quick answer contents may be returned according to the question contents input by the network users.

### FIELD OF THE INVENTION

The present invention relates to an automatic answering system and method and particularly to a customer service automatic answering system and method for use on a Bulletin Board System (BBS) of a customer service Web site.

### BACKGROUND OF THE INVENTION

With the arrival of the information age, the number of network users increases tremendously. One of the hot trends is to get information by linking to a BBS. It indicates that there is a huge development potential in network applications.

A conventional computer system generally has terminals linking to a host. Data input or an inquiry process has gradually shifted from executing programs residing in the host to a workstation process mode. A database collects related data together, and the computer arranges, classifies, adds, and searches data to service users.

Computer terminals exchange information through communication lines. The BBS stores data to be published in a specific database of a computer host to enable any member in the system to access anytime, and publishes the latest news and answers questions posted by users. Hence any member who wants to announce something can do this rapidly through this function.

In network learning applications, the BBS can irregularly publish relevant matters and setup a discussion forum to answer questions to serve as a communication interface between students and teachers.

One of the main issues of the BBS is to provide comprehensive services to customers. In the present BBS, usually users post questions and messages on the BBS if an answer from the network customer service people is required. The network customer service people log on the BBS and read the messages, and answer the questions on the web Page. In such an approach is difficult to create an instant answer. As posting the messages by users and making answering messages by the customer service people take considerable time, information exchange cannot be done instantly. Some Web sites have a Live Person (people providing real time services) to function as onsite representatives of a call center. The Live Person provides instant response, mainly through text discussion to answer user's questions in a one on one fashion. This is a personalized on line service and information exchange.

However, the Live Person service consumes a lot of manpower. In the environment that has a great number of online users and a wide variety of questions, providing one on one service requires a huge investment of human resources. It also is difficult to provide timely response. And online users often have to wait for answers.

Hence there is an urgent need to provide a customer service automatic answering system and method to provide automatic and instant answers and return answer contents to the network users in a timely fashion, without wasting too much manpower on the network customer service function.

### SUMMARY OF THE INVENTION

In view of the aforesaid problems, the primary object of the present invention is to provide a customer service automatic answering system and method to give timely feedback of answer contents for questions posted by users in the BBS.

In order to achieve the foregoing object, the customer service automatic answering system according to the invention automatically provides instant answers and returns answer contents timely based on question contents input by network users. The system includes an answer database to store answering data, each corresponding to a topic content and classified and indexed according to the topic content, an input receiving module to receive question contents entered by the network users, a keyword access module to access keywords based on the question contents, a topic matching module to search all topic contents according to the keywords to find out targeted topic contents that match the keywords, and a delivery module to fetch the answering data corresponding to the targeted topic contents and send the answering data to the network users for displaying.

The customer service automatic answering method according to the invention aims to automatically provide instant answers and return answer contents quickly, based on a question contents input by network users. The method includes, first, establishing an answer database which is classified and indexed according to topic contents; next, receiving question contents entered by users, and accessing keywords of the question contents; searching targeted topic contents that match the keywords in the answer database; and finally sending the answering data corresponding to the targeted topic contents to the network users for displaying.

According to the customer service automatic answering system and method of the invention, after a registered user has posted a question online, response can be made in a short period of time. As the inquired topic is preset, answer contents in the database may be sent to the user end quickly to solve the user's question. This helps to enhance the instant service level.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the module architecture of the customer service automatic answering system of the invention.

FIG. 2 is an overall flow chart of the customer service automatic answering method of the invention.

FIG. 3 is a flow chart of an embodiment for user registration of the invention.

FIG. 4 is a flow chart of an embodiment for automatic returning answer contents of the invention.

FIG. 5 is a flow chart of an embodiment for online answering of the invention.

### DESCRIPTION OF THE PREFERRED EMBODIMENTS

A BBS provides an exchange environment for network users. The customer service automatic answering system of the invention aims to automatically return an answer with contents about a topic corresponding to a question posted by a user, so that the user can get the answer quickly.

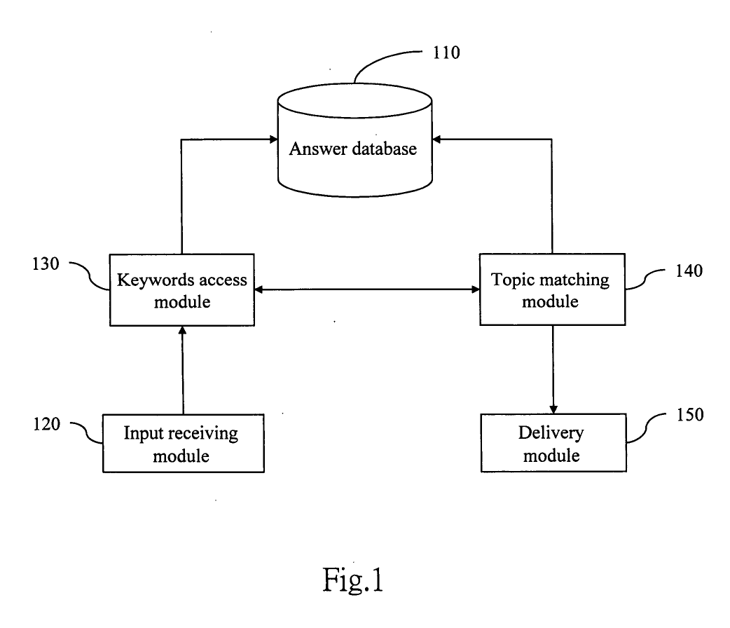

Refer to FIG. 1 for the module architecture of the automatic answering system of the invention. It includes:
1. An answer database 110 to store answering data, each corresponding to a topic content and classified and indexed according to the topic content;
2. An input receiving module 120 to receive question contents entered by network users;
3. A keyword access module 130 to access keywords based on the question contents;
4. A topic matching module 140 to search all topic contents according to the keywords to find targeted topic contents that match the keywords; and
5. A delivery module 150 to fetch the answering data corresponding to the targeted topic contents and send the answering data to the network user for displaying.

The answering data may be sent to an area corresponding to the question contents in the BBS, or by an e-mail or instant message to the user.

The system further includes a question identification module linking to the input-receiving module to identify data attributes input by users. The data attributes include question-data and descriptive data. The module identifies whether the user's input content requires answering.

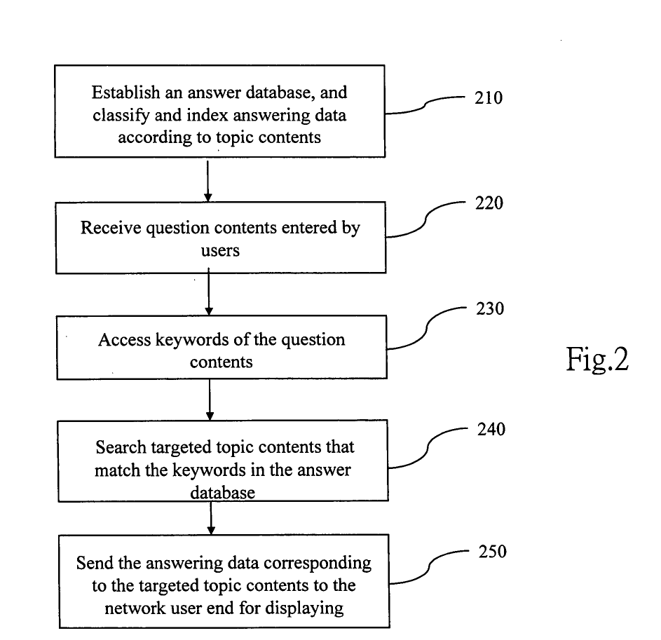

Refer to FIG. 2 for the process flow of the customer service automatic answering method of the invention. First, establish an answer database, and classify and index the answer database according to topic contents (step 210); next, receive question contents entered by users (step 220); access keywords of the question contents (step 230); search targeted topic contents in the answer database that match the keywords (step 240); finally send the answering data corresponding to the targeted topic contents to the network users for displaying (step 250).

More details of the invention are elaborated below, based on the BBS of a customer service Web site.

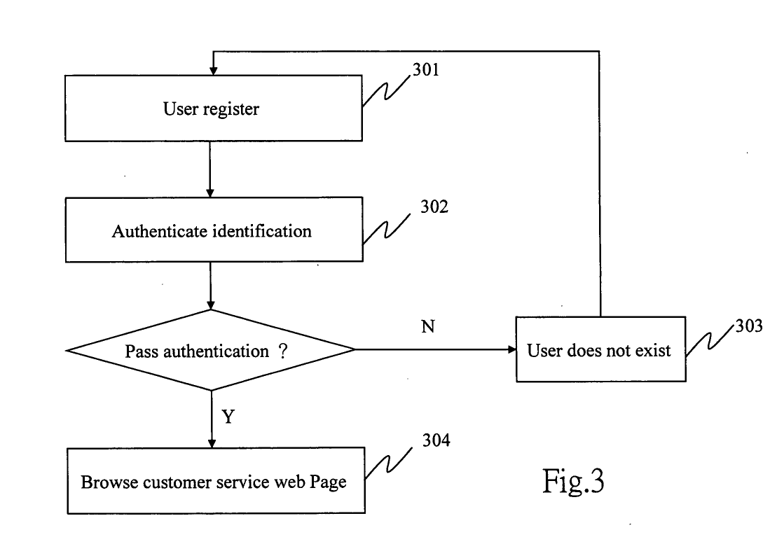

In the BBS, some users encounter problems when using a product and require advice from customer service people. In the invention, a user has to register before entering the BBS, and only the registered users can submit statements. Non-registered users can only read the contents of the Home Page but cannot submit statements. Refer to FIG. 3 for a flow chart for user registration of the invention. First, a user who wants to register has to enter ID and a password on the BBS (step 301); the ID (i.e. account number) is the user's name on the BBS, to identify the network user and provide other network services. In a BBS, an ID cannot be redundant. Once an ID is registered and authorized, it cannot be altered by the user. A BBS generally is less restrictive concerning names. The user may change it anytime. Before registering an ID, a user has only one special ID: as a guest to log on the BBS to read data. After the user has registered and obtained his/her ID, he/she can log on the BBS by his/her ID. Next, the system checks identification (step 302); if the user does not have registration, a message is displayed to indicate that the user does not exist (step 303); if the ID passes a simple register authentication of the Web site, the user can browse the customer service Home Page (step 304), obtain authorization not available to the guest, such as publish articles, enter the chat room to discourse, send messages to other Web users, receive and send mails within or outside the Web site, etc.

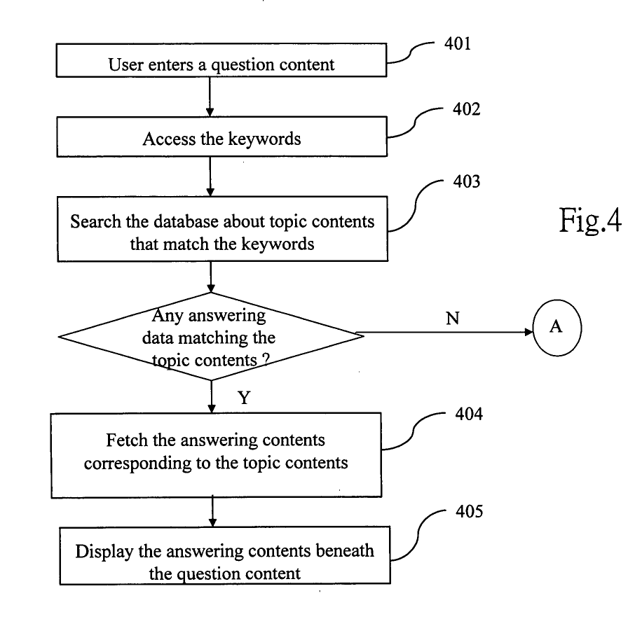

Refer to FIG. 4 for an embodiment of automatic returning answer contents according to the invention. First, a user enters question contents (step 401); next, the system identifies the content attributes input by the user, and determines whether it is a question-data or a descriptive data. This may be identified, based on user's entering area. The Home Page generally has an input area for entering question contents. Hence any content entered in that area is treated as question content. It also may be identified by punctuation marks in the sentences. The accuracy will drop by such an identification method, and identification errors could occur. If the content attributes are confirmed to be the question data, access the keywords in the question contents (step 402); search the database about the topic contents that match the keywords (step 403). The answer database is setup in advance. All answering data in the database are classified and indexed according to the topic contents. If corresponding contents are found in the database, fetch the answering contents corresponding to the topic contents (step 404); finally, display the answering contents beneath the question contents and present them to the resulting answer page to user (step 405). The answering data may also be sent to the corresponding user by an e-mail or instant message.

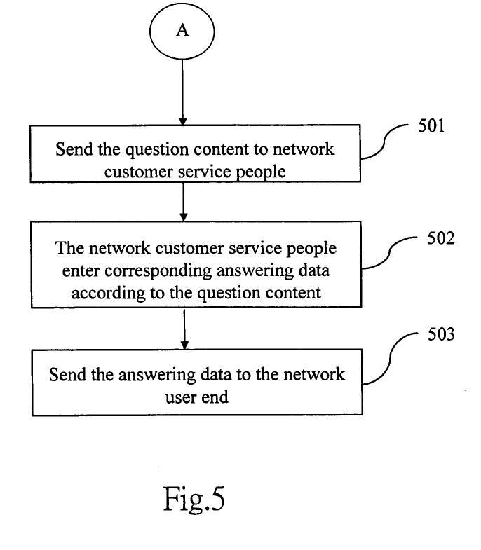

If there is no content matching the keywords, online answering is adopted. Referring to FIG. 5, the question is directly sent to online network customer service people (step 501); the online network customer service people enter corresponding answering data according to the question-contents (step 502); next, send the answering data to the network user end (step 503); and finally collect the users' past questions and answering data, retrieve the keywords, and store the answering data in the answer database. Thus users and customer service people can directly exchange on the network and directly participate in discussions about the question raised by users and answer quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A customer service automatic answering system to perform automatic and instant answering and return answer contents according to question contents input by network users, comprising:
an answer database storing answering data each corresponding to a topic content and being classified and indexed according to the topic content;
an input receiving module receiving the question contents entered by the network users;
a keyword access module accessing keywords based on the question contents;
a topic matching module searching all of the topic content according to the keywords to find out targeted topic contents that match the keywords; and
a delivery module fetching the answering data corresponding to the targeted topic contents and sending the answering data to the network client for displaying.

2. The customer service automatic answering system of claim 1, further including a question identification module linking to the input receiving module to identify data attributes input by users.

3. The customer service automatic answering system of claim 2, wherein the data attributes include questioning data and descriptive data.

4. The customer service automatic answering system of claim 1, wherein the delivery module sends the answering data to the Web site page for displaying.

5. The customer service automatic answering system of claim 1, wherein the displaying is on a location corresponding to the question contents.

6. The customer service automatic answering system of claim 1, wherein the delivery module sends the answering data to a client by an electronic mail.

7. The customer service automatic answering system of claim 1, wherein the delivery module sends the answering data to a client by an instant massage.

8. A customer service automatic answering method to perform automatic and instant answering and return answer contents according to question contents input by network users, comprising the steps of:
establishing an answer database containing answering data classified and indexed according to topic contents of the answering data;
receiving the question contents inputted from users;
accessing keywords of the question contents;
searching a targeted topic contents in the answer database matching the keywords; and
sending the answering data corresponding to the targeted topic contents to the client for displaying.

9. The customer service automatic answering method of claim 8, further including identifying data attributes inputted from users.

10. The customer service automatic answering method of claim 9, wherein the data attributes include questioning data and descriptive data.

11. The customer service automatic answering method of claim 8, wherein the sending the answering data sends the answering data to the Web site page for displaying.

12. The customer service automatic answering method of claim 11, wherein the displaying is on a location corresponding to the question contents.

13. The customer service automatic answering method of claim 8, wherein the sending the answering data sends the answering data to a client by an electronic mail.

14. The customer service automatic answering method of claim 8, wherein the sending the answering data sends the answering data to a client by an instant massage.

15. The customer service automatic answering method of claim 8, wherein the searching targeted topic contents in the database that match the keywords is followed by online answering when no searching result exists, the online answering including the steps of:
sending the question contents to the network customer service people;
entering answering data corresponding to the question contents by the network customer service people; and
sending the answering data to the client.

16. The customer service automatic answering method of claim 15 further including storing the answering data in the answer database.
